(19) United States
(12) Patent Application Publication
(10) Pub. No.: US 2017/0001882 A1
(43) Pub. Date: Jan. 5, 2017

(54) METHODS FOR DECREASING AQUEOUS HALIDE AND ORGANOHALIDE LEVELS USING PLANT BIOMASS

(71) Applicant: INDIAN INSTITUTE OF TECHNOLOGY KHARAGPUR, West Bengal (IN)

(72) Inventors: Debasis ROY, Kolkata (IN); Suvendu MANNA, West Bengal (IN); Ramkrishna SEN, West Bengal (IN); Basudam ADHIKARI, Prembazar (IN); Prosenjit SAHA, Subhaspally (IN)

(73) Assignee: INDIAN INSTITUTE OF TECHNOLOGY KHARAGPUR, West Bengal (IN)

(21) Appl. No.: 15/269,577

(22) Filed: Sep. 19, 2016

Related U.S. Application Data
(62) Division of application No. 14/310,815, filed on Jun. 20, 2014.

(30) Foreign Application Priority Data
Jun. 20, 2013 (IN) 731/KOL/2013

(51) Int. Cl. C02F 1/28; B01J 20/34; B01J 20/30; B01J 20/24; B01J 20/28

(52) U.S. Cl. CPC C02F 1/286; B01J 20/24; B01J 20/28016; B01J 20/3085; B01J 20/3425; B01J 20/3475; C02F 2101/14

(57) ABSTRACT

Disclosed are processes to treat water having halide ions and organohalides. The process comprises contacting a plant biomass with an alkaline solution to give an alkaline plant biomass, and contacting the alkaline plant biomass with water to give a biomass material. An aqueous sample with organohalides or halide ions is contacted with the biomass material to provide a low halide filtrate and a spent biomass.

### RELATED APPLICATION

This application is a divisional application of U.S. application Ser. No. 14/310,815, filed on Jun. 20, 2014, which claims priority benefit under Title 35 §119(a) of Indian Patent Application No. 731/KOL/2013, filed Jun. 20, 2013, the contents of both applications are herein incorporated by reference.

### BACKGROUND

Ground-water is the most widespread source of drinking water. In many parts of the world it is the only source of water. Despite being a relatively safe source for human consumption, groundwater sometimes suffers from various chemical and mineral contaminations including fluoride ions. Long term consumption of such water (fluoride ion concentrations above 1 ppm) can cause damaged and discolored teeth (dental fluorosis) and debilitating bone ailments (skeletal fluorosis) which are irreversible. Preventing or reducing the intake of fluoride ions can reduce the likelihood of undesirable conditions. The purification of groundwater, and other water supplies, could be an important step in reducing the intake of fluoride ions.

Two-thirds of all fluoride salts mined is used in the electrolysis of aluminum and the production of steel. Fluoride and other halide salts are also used in the industrial production of ceramics, enamels, glass fibers, cement, agrichemicals, and other industries. The present application recognizes the need to lower the levels of various halide ions and organohalides in drinking water as well as in lakes, swimming pools, industrial waste, and agricultural run-off.

### SUMMARY

In a first embodiment the present application describes a method for reducing halide content in an aqueous sample, the method comprising: providing a plant biomass; contacting a plant biomass with an alkali solution to give an alkaline plant biomass; contacting the alkaline plant biomass with water to give a biomass material; and contacting an aqueous sample suspected of containing one or more halides with the biomass material to yield a reduced halide concentration sample and an at least partially spent biomass material. An additional embodiment of the present application comprises heating the plant biomass with water prior to contacting the plant biomass with alkali solution. An additional embodiment of the present application comprises boiling the plant biomass with water prior to contacting the plant biomass with alkali solution. An additional embodiment of the present application comprises trans-esterifying the biomass material before contacting the biomass material with an aqueous sample. An additional embodiment of the present application comprises trans-esterifying the biomass material by contacting the biomass material with vegetable oil, fatty acid emulsion, phenolic resin, or a combination thereof, before contacting the biomass material with an aqueous sample. An additional embodiment of the present application comprises trans-esterifying the biomass material by contacting the biomass material with vegetable oil, fatty acid emulsion, phenolic resin, or a combination thereof, at a temperature of about 95° C. to about 120° C. An additional embodiment of the present application comprises washing the biomass material with at least one organic solvent. An additional embodiment of the present application exists, wherein the organic solvent is ethanol, acetone, methanol, propanol, or a combination thereof. An additional embodiment of the present application comprises drying the biomass material before contacting the biomass material with the aqueous sample. An additional embodiment of the present application comprises drying the biomass material at a temperature of about 55° C. to about 80° C. before contacting the biomass material with the aqueous sample. An additional embodiment of the present application comprises regenerating the at least partially spent biomass material by contacting it with an acid solution to give a backwash solution. An additional embodiment of the present application exists, wherein the acid solution has a pH of about 2 to about 4. An additional embodiment of the present application exists, wherein the acid is hydrochloric acid, acetic acid, citric acid, or a combination thereof. An additional embodiment of the present application comprises contacting the backwash solution with calcium chloride, calcium carbonate, or a combination thereof to give a calcium fluoride precipitate. An additional embodiment of the present application exists, wherein the plant biomass has an average particle size equal to or less than about 1000 microns. An additional embodiment of the present application exists, wherein the plant biomass has an average particle size of about 1 microns to about 1000 microns. An additional embodiment of the present application exists, wherein the plant biomass comprises water hyacinth, elephant grass, jute, water lily, duck weed, azolla, wood, coir, banana, ramie, pineapple, sisal, or a combination thereof. An additional embodiment of the present application exists, wherein the plant mass comprises plant parts are comprised of cellulose, hemicelluloses, lignin, or a combination thereof. An additional embodiment of the present application exists, wherein the alkali solution is about 0.5% alkali to about 1.0% alkali by weight. An additional embodiment of the present application exists, wherein the alkali solution is about 0.5% alkali to about 1.0% alkali by weight, and the alkali is sodium hydroxide, potassium hydroxide, calcium hydroxide, or a combination thereof. An additional embodiment of the present application exists, wherein the alkali solution has a pH of about 11 to about 13. An additional embodiment of the present application exists, wherein the alkali solution has a pH of about 12. An additional embodiment of the present application exists, wherein the contacting with alkali solution comprising contacting the biomass for at least about 18 hours at a temperature equal to or greater than about 0° C. An additional embodiment of the present application comprises contacting with alkali solution comprising contacting the biomass at least 9 hours at a temperature equal to or greater than about 20° C. An additional embodiment of the present application comprises contacting with alkali solution comprising contacting the biomass at least 90 minutes at a temperature equal to or greater than about 70° C. An additional embodiment of the present application comprises contacting with alkali solution is for at least 20 minutes at a temperature of about 100° C. to about 130° C. An additional embodiment of the present application comprises contacting with alkali solution at a temperature of about 30° C. to about 100° C. An additional embodiment of the present application comprises contacting with alkali solution is for at least 12 hours. An additional embodiment of the present application comprises contacting the alkaline plant biomass with water the pH of the biomass material is about 7 to about pH 9. An additional embodiment of the present application comprises contacting the alkaline plant biomass with water the pH of the biomass material is about 7. An additional embodiment of the present application exists, wherein the sample has a pH of about 3 to about 8. An additional embodiment of the present application comprises, wherein the volume of the sample is equal to or less than twice an effluent volume of the biomass material. An additional embodiment of the present application exists, wherein the concentration of the halide in the aqueous sample has been reduced by at least 90% in the reduced halide concentration sample. An additional embodiment of the present application exists, wherein the concentration of halide in the aqueous sample has been reduced by at least 95% in the reduced halide concentration sample. An additional embodiment of the present application exists, wherein the halide comprises a fluoride. An additional embodiment of the present application exists, wherein the halide comprises an iodide. An additional embodiment of the present application exists, wherein the halide comprises an organohalide. An additional embodiment of the present application exists, wherein the halide comprises 2,4-dichlorophenoxyacetic acid.

In a second embodiment the present application describes a bio filter comprising a plant-based biomass having an average particle size equal to or less than about 1000 microns. An additional embodiment of the present application exists, wherein the average particle size of the biomass is about 1 microns to about 1000 microns. An additional embodiment of the present application exists, wherein the plant-based biomass comprises water hyacinth, elephant grass, jute, water lily, duck weed, azolla, wood, coir, banana, ramie, pineapple, sisal, or a combination thereof. An additional embodiment of the present application exists, wherein the plant-based biomass comprises plant parts, and wherein the plant parts comprise cellulose, hemicelluloses, lignin, or a combination thereof. An additional embodiment of the present application exists, wherein the plant-based biomass is in a containment structure having an influent inlet, an effluent outlet, and configured to pass a fluid from the influent inlet through the plant-based biomass, and then through the effluent outlet. An additional embodiment of the present application further comprises an outlet filter between the plant-based biomass and the effluent outlet. An additional embodiment of the present application further comprises an inlet filter between the plant-based biomass and the influent inlet.

### BRIEF DESCRIPTION OF THE DRAWINGS

For a clear understanding of the nature and advantages of the present disclosure, reference should be made to the following detailed description taken in connection with the accompanying drawings, in which:

FIG. 1 illustrates a simplified flow diagram of an aspect of the disclosure.

FIG. 2 is a chart illustrating the removal percent of fluoride, iodide, and 2,4- dichlorophenoxyacetic acid according to an embodiment of the disclosure. The diamond symbols represent fluoride. The square symbols represent iodide. The round symbols represent 2,4-D. The x-axis is biomass amount in grams per 50 mL of water sample. The y-axis is percent removal.

FIG. 3 is a chart illustrating the output halide level and volume percent removal of fluoride comparing a transesterified plant biomass and a biomass without transesterification The diamond symbols represent Biomass 1. The square symbols represent Biomass 2. The x-axis is effluent volume in liters. The y-axis is outlet concentration expressed as a fraction of the concentration at the inlet.

FIG. 4 is a chart illustrating the removal of fluoride from 50 mL of water using various quantities of biomass. The diamond symbols represent fluoride. The x-axis is biomass amount in grams per 50 mL of water sample. The y-axis is percent removal.

### DETAILED DESCRIPTION

Before the present compositions and methods are described, it is to be understood that they are not limited to the particular compositions, methodologies or protocols described. It is also to be understood that the terminology used in the description is for the purpose of describing the particular versions or embodiments only, and is not intended to limit their scope.

Disclosed is a process to treat water having halides including halide ions and/or organohalides. The process includes contacting a plant biomass with an alkaline solution to give an alkaline plant biomass, contacting the alkaline plant biomass with water to give a biomass material; and passing water suspected of having or having halide ions and/or organohalides through the biomass material to provide water with reduced halides and an at least partially spent biomass.

The plant biomass may include plant parts. In some embodiments, the plant parts include, but are not limited to cellulose, hemicelluloses, lignin, leaves, non-woody stems, and woody stems of plants, or a combination thereof In certain embodiments, the plant parts are derived from water hyacinth, elephant grass, jute, water lily, duck weed, azolla, wood, coir, banana, ramie, pineapple, sisal, or a combination thereof. The plant biomass may be cut into smaller particles by any means known to those skilled in the art. In some embodiments, raw plant material is made into smaller pieces by any available technique such as but not limited to cutting, shredding, pulverizing, blending, granulating, or a combination thereof.

In some embodiments, the plant biomass has an average particle size of about 1 micron to about 5000 microns. In some embodiments, the average particle size is about 10 microns to 1000 microns. In some embodiments, the average particle size is about 50 microns to 1000 microns. In some embodiments, the average particle size is about 500 microns to about 1000 microns. In some embodiments, the average particle size is about 10 microns, about 20 microns, about 30 microns, about 50 microns, about 100 microns, about 250 microns, about 500 microns, about 1000 microns, about 2500 microns, about 5000 microns, or any range between any two of these values.

As stated above, the process includes contacting a plant biomass with an alkali solution to give an alkaline plant biomass. In some embodiments, the alkali solution is about 0.5% alkali to about 1.0% alkali by weight. In other embodiments, the alkali solution is about 0.25% alkali to about 2.0% alkali. In still other embodiments, the alkali solution is about 0.1% alkali to about 4.0% alkali. In some embodiments, the alkali solution has a pH of about 11 to about 14. In some embodiments, the alkali solution has a pH of about 11 to about 13. In certain embodiments, the alkali solution has a pH of about 12. In various embodiments, the alkali is sodium hydroxide, potassium hydroxide, calcium hydroxide, or a combination thereof.

In various embodiments, the contacting of the plant biomass with an alkali solution to give an alkaline plant biomass is for about 18 hours to about 36 hours at a temperature of not less than about 0° C., for about 12 hours to about 24 hours at a temperature of not less than about 10° C., for about 10 hours to about 15 hours at a temperature of not less than about 20° C., for about 6 hours to about 10 hours at a temperature of not less than about 30° C., for about 4.5 hours to about 8 hours at a temperature of not less than about 40° C., for about 3 hours to about 5 hours at a temperature of not less than about 50° C., for about 2.25 hours to about 4 hours at a temperature of not less than about 60° C., for about ninety minutes to about 3 hours at a temperature of not less than about 70° C., for about seventy minutes to about 2 hours at a temperature of not less than about 80° C., for about 45 minutes to about 1.5 hours at a temperature of not less than about 90° C., for about 24 minutes to about 1 hour at a temperature of not less than about 100° C., for about 18 minutes to about 40 minutes at a temperature of not less than about 110° C.

As stated above, the process includes contacting the alkaline plant biomass with water to give a biomass material. Contacting the alkaline plant biomass with water lowers the pH of the biomass material. In some embodiments, contacting brings the pH of the biomass material to a pH less than about 9.0. In other embodiments, contacting brings the pH of the biomass material to a pH less than about 8.0. In still other embodiments, contacting brings the biomass material to a pH of less than about 7.5. In another embodiment, contacting brings the biomass material to a pH of less than about 7.

As stated above, the process includes passing water suspected of having or having halide ions or organohalides through the biomass material to provide a lowered halide water filtrate and an at least partially spent biomass. In an embodiment, the water before passing has a pH of about 2 to about 9. In other embodiments, the water before passing has a pH of about 3 to about 8. In still other embodiments, the water before passing has a pH of about 4 to about 7.5. In yet other embodiments, the water before passing has a pH of about 4 to about 7.5. In some embodiments, the water before treatment has a pH of about 2, about 3, about 4, about 7.5, about 8, about 9, or any range between and two of these values.

In some embodiments, the volume of the water that may be passed through the alkaline plant biomass is ten times the effluent volume of the alkaline plant biomass before the alkaline plant biomass needs to be regenerated or discarded. In other embodiments, the alkaline plant biomass is four times the effluent volume of the alkaline plant biomass before regeneration or discarding. In still other embodiments, the alkaline plant biomass is two times the effluent volume of the alkaline plant biomass. In other embodiments, the alkaline plant biomass is any range between any two of these values.

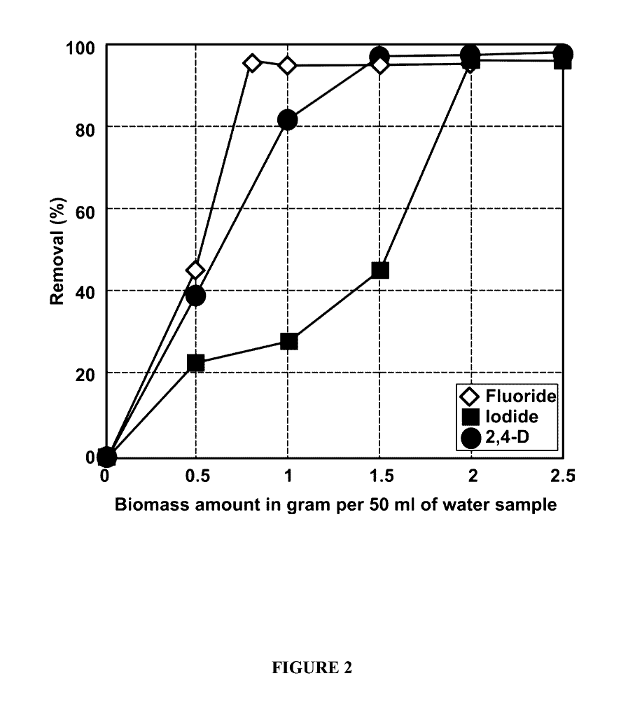

Halide concentration is reduced by passing the water containing halide ions and/or organohalides through the biomass material. FIG. 2 is a graph showing the removal percentage of fluoride, iodide, and 2,4-dichlorophenoxyacetic acid (2,4-D) from an aqueous sample. The halide ion solution was prepared using 10 milligrams of the halides per liter. Thus, the halides were 10 parts per million. The graph shows that using 0.5 grams of biomass, 50 milliliters (mL) of water was processed to remove about 43% of the fluoride, about 22% of the iodide, and about 39% of the 2,4-D. Adding two grams of biomass per 50 mL of the contaminated water removed about 95% of the fluoride, about 95% of the iodide, and about 98% of the 2,4-D.

In various embodiments, the halides may be halide ions or organohalides. Halide ions include fluoride, chloride, bromide, iodide, or a combination thereof In some embodiments, the halide is fluoride. In other embodiments, the halide is iodide. In still other embodiments, the halide is chloride. In yet other embodiments, the halide is an organohalide. Organohalides include compounds having a chlorinated aromatic ring, a chlorinated heteroaryl ring, a chlorinated triazine compound, or an organocycloalkane. Representative herbicides and/or insecticides that may be removed by the biomass material include, but are not limited to, 2,4- dichlorophenoxyacetic acid (2,4-D), 1,1,1-trichloro-2,2-di(4-chlorophenyl)ethane (DDT), 4- amino-3,6-dichloropyridine-2-carboxylic acid (aminopyralid), 1,2,3,4,10,10-hexachloro- 1,4,4a,5,8,8a-hexahydro-1,4:5,8-dimethanonaphthalene (aldrin), (1aR,2R,2aS,3 S,6R,6aR,7S, 7aS)-3,4,5,6,9,9-hexachloro-1a,2,2a,3,6,6a,7,7a-octahydro-2,7:3,6-dimethanonaphtho[2,3-b]- oxirene (dieldrin), 6,7,8,9,10,10-hexachloro-1,5,5a,6,9,9a-hexahydro-6,9-methano-2,4,3- benzodioxathiepine-3-oxide (eldosulfan), 1,2,4,5,6,7,8,8-octachloro-2,3,3a,4,7,7a-hexahydro- 4,7-methanoindene (heptachlor), octachloro-4,7-methanohydroindane (chlordane), (1aR,2S,2aS, 3S,6R,6aR,7R,7aS)-3,4,5,6,9,9-hexachloro-1a,2,2a,3,6,6a,7,7a-octahydro-2,7:3,6-dimethano- naphtho[2,3-b]oxirene (endrin), 1,1a,2,2,3,3a,4,5,5,5a,5b,6-dodecachlorooctahydro-1H-1,3,4- (methanetriyl)cyclobuta[cd]pentalene (mirex), 3,6-dichloro-2-pyridinecarboxylic acid (clopyralid), 4-amino-3,5,6-trichloro-2-pyridinecarboxylic acid (picloram), [(3,5,6-trichloro-2- pyridinyl)oxy]acetic acid (triclopyr), 1-chloro-3-ethylamino-5-isopropylamino-2,4,6-triazine (atrazine), polychlorinated biphenols, polychlorinated dibenzo-p-dioxin, or a combination thereof In an embodiments, the organohalide is 2,4-D.

Herbicides may be reduced by passing the water containing an organohalide through the biomass material. FIG. 2 is a graph showing the removal percentage of 2,4- dichlorophenoxyacetic acid (2,4-D). 2,4-D was prepared at 10 parts per million in water using 10 milligrams of 2,4-D per liter. The graph shows that using 0.5 grams of alkaline plant biomass in 50 mL of the water containing an organohalide removed about 39% of the 2,4-D present. Adding 1.5 grams of biomass per 50 mL removed about 98% of the 2,4-D. Stated differently, the process lowered 2,4-D concentration from 10 ppm to approximately 200 ppb.

As used herein, “phenolic resin” refers to condensation products of an aldehyde with a phenol source in the presence of an acidic or basic catalyst, or the natural resin from the cashew nutshell. The phenol source can be, for example, phenol, alkyl-substituted phenols such as cresols and xylenols; polyhydric phenols such as resorcinol or pyrocatechol; polycyclic phenols such as naphthol; aryl-substituted phenols; aryloxy-substituted phenols; and the like, or a combination thereof. In various aspects, the phenol source can be phenol, 2,6- xylenol, o-cresol, p-cresol, 3,5-xylenol, 3,4-xylenol, 2,3,4-trimethyl phenol, 3-ethyl phenol, 3,5- diethyl phenol, p-phenyl phenol, 3,5-dimethoxy phenol, 3,4,5-trimethoxy phenol, p-ethoxy phenol, 3-methyl-4-methoxy phenol, p-phenoxy phenol, multiple ring phenols, or a combination thereof. The aldehyde for use in making the phenolic resin can be, for example, formaldehyde, paraformaldehyde, acetaldehyde, butyraldehyde, paraldehyde, glyoxal, furfuraldehyde, propinonaldehyde, benzaldehyde, or a combination thereof. In various aspects, the aldehyde can be formaldehyde. In various aspects, phenolic resin is cashew nutshell liquid.

The term “alkyl” as used herein means acyclic, straight or branched chain hydrocarbon substituents having 1-3 carbon atoms and includes, for example, methyl, ethyl, propyl, and 1-methylethyl.

The term “aryl” as used herein means an aromatic moiety containing 0, 1, 2, 3, or 4 heteroatoms (e.g., N, O, S, or the like) such as, but not limited to phenyl, indanyl or naphthyl, pyridyl, diazinyl, and triazinyl. An aryl may be mono, di, tri, tetra, or penta substituted with one or more aryl substituents. An aryl substituent may include typical substituents known to those skilled in the art, e.g., halogen, hydroxy, carboxy, carbonyl, nitro, sulfo, amino, cyano, dialkylamino haloalkyl, trifluoromethyl, haloalkoxy, thioalkyl, alkanoyl, SH, alkylamino, alkylamide, dialkylamide, carboxyalkyl ether, carboxyester, alkylsulfone, alkylsulfonamide, and alkyl(alkoxy)amine.

In various embodiments of the above process, the plant biomass may be pre-treated. The process may further include heating the plant biomass in water prior to contacting the aqueous biomass with alkali solution. The alkali solutions include, but are not limited to, aqueous potassium hydroxide, aqueous sodium hydroxide, and aqueous calcium hydroxide. Specific examples of alkali concentrations include about 0.1%, about 0.5%, about 1.0%, about 2.5%, about 5.0%, and ranges between any two of these values including endpoints.

In various embodiments, the process further includes trans-esterifying the biomass material before contacting the biomass material with an aqueous sample. In some embodiments, trans-esterifying the biomass material includes contacting the biomass material with a vegetable oil, a fatty acid emulsion, phenolic resin, or a combination thereof. Vegetable oil includes, but is not limited to, neem oil, rice bran oil, and rice bran oil fatty acid distillate, or a combination thereof. Fatty acids may include, but are not limited to, oleic acid, palmitic acid, linoleic acid, linolenic acid, or a combination thereof.

A fatty acid emulsion may be prepared by emulsifying fatty acids in water and an alkali agent. Specific examples of concentrations of fatty acids in water include about 0.5%, about 1.0%, about 2.5%, about 5.0%, about 10.0%, about 20.0%, and ranges between any two of these values including endpoints. Specific examples of alkali concentrations include about 0.05%, about 0.1%, about 0.5%, about 1.0%, about 2.5%, and ranges between any two of these values including endpoints. The alkali agent includes, but is not limited to, potassium hydroxide, aqueous sodium hydroxide, and aqueous calcium hydroxide.

In certain embodiments, the trans-esterifying the biomass material is performed at a temperature of about 95° C. for at least about one hour. In other embodiments, the trans-esterifying the biomass material is performed at a temperature of about 95° C. to about 120° C. for at least about one hour. Transesterification is optional. In certain embodiments, the trans-esterified material may be washed before further use. In some embodiments, the wash comprises at least one organic solvent. In other embodiments, the wash comprises at least one organic solvent and water. The organic solvent may include ethanol, acetone, methanol, propanol, or a combination thereof.

In certain embodiments, the method further includes trans-esterifying the biomass material by contacting the biomass material with vegetable oil, fatty acid emulsion, phenolic resin, or a combination thereof, at a temperature of about 95° C. for at least about one hour, then washing the biomass material with at least one organic solvent. In certain embodiments, the method further includes trans-esterifying the biomass material by contacting the biomass material with vegetable oil, fatty acid emulsion, or a combination thereof, and at least one phenolic resin, at a temperature of about 95° C. to about 120° C., then washing the biomass material with ethanol, acetone, methanol, propanol, or a combination thereof. Vegetable oil includes, but is not limited to, neem oil, rice bran oil, and rice bran oil fatty acid distillate.

The plant biomass material may optionally be dried. In various embodiments, the method further includes drying the biomass material before contacting the biomass material with the aqueous sample. In various embodiments, the method further includes drying the biomass material at a temperature of about 50° C. to about 105° C. In various embodiments, the method further includes drying the biomass material at a temperature of about 55° C. to about 80° C., or from about 60° C. to about 70° C.

The plant biomass may optionally be regenerated. In some embodiments, the method further includes regenerating the biomass material by passing through an acid solution. The biomass material may be passed continuously in a forward flow or in a reverse flow through the acid solution. In certain embodiments, the regeneration may be carried out in a batch mode. In certain embodiments, the method further includes regenerating the biomass material with an acid solution having a pH of not less than about 2 and not greater than about 4. In other embodiments, the method further includes regenerating the biomass material with an acid solution having a pH of not less than about 2, and not greater than about 4, wherein the acid is hydrochloric acid, acetic acid, or citric acid. The filtrate generated from the acid solution and biomass material is a backwash solution. In some embodiments, the regeneration may be performed up to five times. In other embodiments, the biomass may be regenerated indefinitely, until the biomass breaks down structurally.

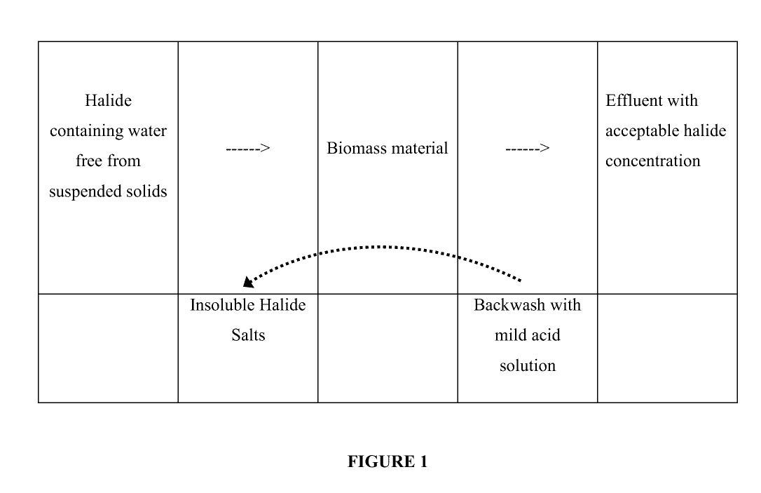

Fluoride is optionally removed from the backwash solution as illustrated in FIG. 1. Various embodiments include contacting the backwash solution with calcium chloride, calcium carbonate, or a combination thereof to give a calcium fluoride precipitate.

Another aspect of the technology is a bio-filter including a plant-based biomass having an average particle size equal to or less than about 1000 microns. In some embodiments, the biomass has an average particle size of about 1 micron to about 1000 microns. The plant-based biomass may include water hyacinth, elephant grass, jute, water lily, duck weed, azolla, wood, coir, banana, ramie, pineapple, sisal, or a combination thereof. The plant-based biomass may include plant parts that comprise cellulose, hemicelluloses, lignin, or a combination thereof. The bio-filter may further include a containment structure, an influent inlet, and an effluent outlet configured to pass fluid from the influent inlet through the plant-based biomass, and through the effluent outlet. In some embodiments, the bio-filter includes an outlet filter between the plant-based biomass and the effluent outlet, and an inlet filter between the plant-based biomass and the influent inlet, or includes both an outlet filter and an inlet filter.

### EXAMPLES

This technology and embodiments illustrating the method and materials used may be further understood by reference to the following non-limiting examples.

### Example 1

### Preparation of Biomass from Water Hyacinth

Preparation of biomass. Raw water hyacinth plant biomass was chopped by a mechanical chopper to an average size of 1000 micron to 50 microns. The biomass particle size was determined using a laser particle size analyzer (commercial model Malvern Instruments Mastersizer 2000). The chopped plant biomass was boiled in water using a biomass to water ratio of 1:20 (weight:volume). The plant biomass was charged with 0.5% sodium hydroxide solution having a pH of about 12.0. The alkali mixture was heated by steam at about 100 kPa (gauge) at about 121° C. for about 18 hours. The biomass was then washed with water.

### Example 2

### Preparation of Biomass from Elephant Grass

Preparation of dried biomass. Raw elephant grass plant biomass was chopped by a mechanical chopper to an average size of 1000 micron to 50 microns. The biomass particle size was determined using a laser particle size analyzer (commercial model Malvern Instruments Mastersizer 2000). The chopped plant biomass was boiled in water with a biomass to water ratio of 1:20 (weight:volume). The boiled plant biomass was charged with 0.75% potassium hydroxide solutions having a pH of about 12. The alkali mixture was heated by steam at 100 kPa (gauge) at about 121° C. for about 15 hours. The biomass was then washed with water and subsequently with ethanol. The biomass was dried in an oven at about 65° C. to about 80° C.

### Example 3a

### Preparation of Partially Transesterified Biomass from Jute

Raw jute plant biomass was chopped to an average 1000 micron to 50 micron in size by a mechanical chopper. The biomass particle size was determined using a laser particle size analyzer (commercial model Malvern Instruments Mastersizer 2000). The chopped plant biomass was boiled in water with a biomass to water ratio of 1:20 (weight:volume). The plant biomass was charged with 1% calcium hydroxide solution having a pH of about 12. The alkali mixture was heated by steam at 100 kPa (gauge) at about 121° C. for about 12 hours. The biomass was then washed with water. To the alkali treated biomass was added a vegetable oil-phenolic resin emulsion with a biomass to emulsion ratio of 1:2 (weight:volume). The mixture was stirred with heating at 110° C. for about 1 hour for partial transesterification. The transesterified biomass was cooled to ambient temperature and rinsed with acetone. The biomass was dried in an oven at about 65° C. to about 80° C.

### Example 3b

### Preparation of Vegetable Oil Emulsion Treated Biomass

Alkali-treated biomass was treated with an aqueous alkaline emulsion (9 to 11 pH) prepared by mixing 2 to 3.5% of vegetable oil and 0.2 to 0.5% alkali. 100 mL of this emulsion was sprayed uniformly on 200 grams of the alkali-treated biomass before curing the treated biomass at 90° C. to 110° C. for 1 hour to 2 hours.

Similarly, vegetable oil emulsion treated biomasses were prepared using neem oil, rice bran oil, and rice bran oil fatty acid distillate.

Preparations included the use of alkali solutions of KOH, NaOH, and Ca(OH)₂.

### Example 3c

### Preparation of Vegetable Oil-phenolic Resin Treated Biomass

Batches of alkali treated biomass were treated with an aqueous alkaline emulsion (of about 9 to about 11 pH) prepared by mixing 2 to 3.5% of vegetable oil, 1 to 2% resorcinol, 2 to 4% cashew nut shell liquid, 0.5 to 1.3% formaldehyde and 0.2 to 0.5% alkali maintaining 0.5% to 1.0% solid content. 100 ml of this emulsion was sprayed uniformly on 200 grams of the alkali-treated biomass before curing the treated biomass at 90 to 110° C. for 1 h to 2 h

Preparations included the use of alkali solutions of KOH, NaOH, and Ca(OH)₂.

Examples of various biomass prepared by the methods of Examples 1-3c are included in Table 1:

TABLE 1

| | |
|---|---|
| Name of the | Treatment |

| biomass | Alkali | Transesterification |
|---|---|---|
| Jute | Yes | Yes |
| Water hyacinth | Yes | No |
| Elephant grass | Yes | No |
| Banana | Yes | Yes |
| Coir | Yes | Yes |
| Sisal | Yes | Yes |
| Wood | Yes | Yes |
| Duck weed | Yes | No |
| Azolla | Yes | No |
| Water lily | Yes | No |

### Example 4a

### Reduction of Aqueous Fluoride Levels

As shown in FIG. 2, a first sample of 50 mL of water containing 10 milligrams/liter (mg/L) of fluoride was mixed with the partially transesterified biomass prepared in Example 3. The fluoride containing water was mixed with 0.5 grams of the biomass by shaking at 120 rpm at 35° C. for 3 hours. Analysis of the water after filtration showed that about 43% of the fluoride had been removed.

A second sample of 50 mL of water containing 10 mg/L of fluoride was shaken as above with 1 gram of biomass prepared in Example 1. Analysis of the water after filtration showed that about 96% of the fluoride had been removed.

A third sample of 50 mL of water containing 10 mg/L of fluoride was shaken as above with 2 grams of biomass prepared in Example 1. Analysis of the water after filtration showed that about 95% of the fluoride was removed. Additional samples using 0.8 grams or 1.5 grams of biomass each removed about 95% of the fluoride.

Fluoride removal was found to increase with the amount of biomass. In each instance, the 95% reduction in fluoride levels achieved brings the fluoride level to within the permissible World Health Organization (WHO) limits for potable water. The WHO limit for fluoride concentration in drinking water is 1.5 mg/liter (World Health Organization (WHO). 2011. Guideline for drinking-water quality. Fourth edition. World Health Organization, Geneva).

### Example 4

### Reduction of Aqueous Fluoride Levels

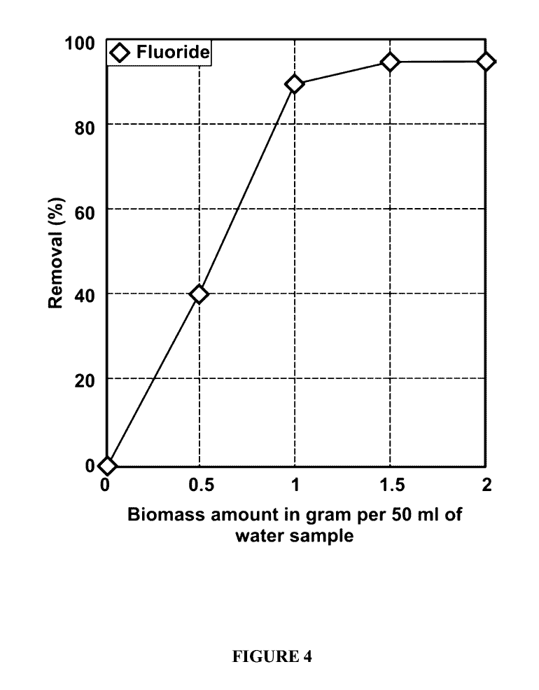

As shown in FIG. 4, a first sample of 50 mL of water containing 5 mg/L of fluoride was mixed with a partially transesterified biomass prepared in Example 3b. The fluoride containing water was mixed with 0.5 grams of the biomass by shaking at 120 rpm at 35° C. for 3 hours. Analysis of the water after filtration showed that about 40% of the fluoride had been removed.

A second sample of 50 mL of water containing 5 mg/L of fluoride was shaken as above with 1 gram of biomass prepared in Example 1. Analysis of the water after filtration showed that about 90% of the fluoride had been removed.

A third sample of 50 mL of water containing 5 mg/L of fluoride was shaken as above with 2 grams of biomass prepared in Example 1. Analysis of the water after filtration showed that about 96% of the fluoride was removed. Additional samples using 0.8 grams or 1.5 grams of biomass each removed about 95% of the fluoride.

Fluoride removal was found to increase with the amount of biomass. The 95% reduction brings the fluoride level to below the permissible World Health Organization (WHO) limits for potable water.

### Example 5

### Reduction of Aqueous Iodide Levels

As shown in FIG. 2, a first sample of 50 mL of water containing 10 mg/L of iodide was mixed with a biomass that had been transesterified in one of Examples 3a-c. The water was mixed with 0.5 grams of biomass by shaking at 120 rpm at 35° C. for 3 hours. Analysis of the water after filtration showed that about 22% of the iodide was removed.

A second sample of 50 mL of water containing 10 mg/L of iodide was shaken as above with 1 gram of biomass from Example 1. Analysis of the water after filtration showed that about 27% of the iodide was removed.

A third sample of 50 mL of water containing 10 mg/L of iodide was shaken as above with 1.5 grams of biomass from Example 1. Analysis of the water after filtration showed that about 44% of the iodide was removed.

A fourth sample of 50 mL of water containing 10 mg/L of iodide was shaken as above with 2 grams of biomass from Example 1. Analysis of the water after filtration showed about 95% of the iodide had been removed.

A fifth sample of 50 mL of water containing 10 mg/L of iodide was shaken as above with 2.5 grams of biomass of Example 1. Analysis of the water after filtration showed that about 95% of the iodide had been removed.

Iodide removal was found to increase with the amount of biomass.

### Example 6

### Reduction of Aqueous 2,4-Dichlorophenoxyacetic acid (2,4-D) Levels

As shown in FIG. 2, a first sample of 50 mL of water containing 10 mg/L of 2,4-D was mixed with a biomass of Example 1 that had been alkali treated. The water was mixed with 0.5 grams of biomass by shaking at 120 rpm at 35° C. for 3 hours. Analysis of the water after filtration showed that about 39% of the 2,4-D had been removed.

A second sample of 50 mL of water containing 10 mg/L of 2,4-D was shaken as above with 1 gram of biomass of Example 1. Analysis of the water after filtration showed that about 82% of the 2,4-D had been removed.

A third sample of 50 mL of water containing 10 mg/L of 2,4-D was shaken as above with 1.5 grams of biomass of Example 1. Analysis of the water after filtration showed that about 98% of the 2,4-D had been removed.

A fourth sample of 50 mL of water containing 10 mg/L of 2,4-D was shaken as above with 2 grams of biomass of Example 1. Analysis of the water after filtration showed that about 98% of the 2,4-D had been removed.

A fifth sample of 50 mL of water containing 10 mg/L of 2,4-D was shaken as above with 2.5 grams of biomass of Example 1. Analysis of the water after filtration showed that about 98% of the 2,4-D had been removed.

2,4-D removal was found to increase with the amount of biomass.

### Example 7

### Reduction of Aqueous Fluoride Levels using Column Elution

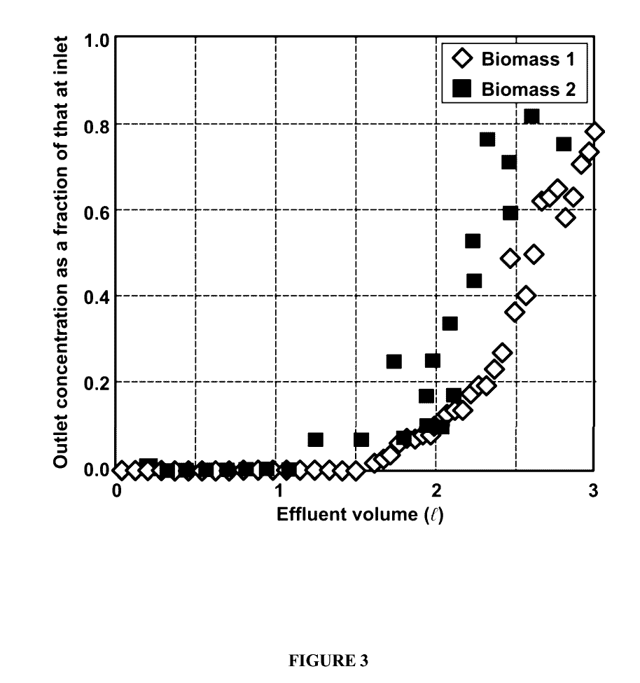

Removal of Fluoride by Column: A column was prepared having a biomass 50-mm in height, and containing 3 grams of the biomass prepared as in Example 1. Water having 5 mg/L fluoride was added to the column. The fluoridated water was eluted through the column at 10 mL/minute. The outlet concentration of fluoride as a fraction of the fluoride concentration of the inlet was plotted as shown in FIG. 3, open diamonds. One and one-half liters of water had been collected, the collected water having no detected fluoride. After about 3 L of eluent, the biomass was not able to remove more than 20% of the fluoride.

### Example 8

### Reduction of Aqueous Fluoride Levels using Column Elution

Removal of Fluoride by Column: A column was prepared having biomass 50-mm in height, and containing 3 grams of transesterified biomass prepared in Example 3. Water having 5 mg/L fluoride was added to the column. The fluoridated water was eluted through the column at 10 mL/minute. The outlet concentration of fluoride as a fraction of the fluoride concentration of the inlet was plotted as shown by the black squares in FIG. 3. One liter of water was collected, the water having no detected fluoride. After 2.5 L, the biomass was not able to remove more than 20% of the fluoride.

### Example

### Regeneration of the Biomass

The biomass from Example 6 was treated by washing with a dilute aqueous solution of hydrochloric acid to give a filtrate as a backwash solution, the backwash solution having a pH of about 5.

The backwash solution containing the fluoride was treated with a solution of calcium chloride, producing a calcium fluoride precipitate. The calcium fluoride was isolated by filtration.

Similarly, another backwash solution containing the fluoride was treated with a solution of calcium carbonate, producing a calcium fluoride precipitate. The calcium fluoride was isolated by filtration.

What is claimed is:

1. A method for removing a halide, a herbicide, or a combination thereof in an aqueous sample, the method comprising:
contacting a plant biomass with an alkali solution to give an alkaline plant biomass;
trans-esterifying the alkaline plant biomass to obtain a treated plant biomass; and
contacting the treated plant biomass with the aqueous sample to remove the halide, the herbicide, or a combination thereof from the aqueous sample.

2. The method of claim 1, further comprising washing the treated plant biomass before contacting the aqueous sample.

3. The method of claim 2, wherein washing the treated plant biomass comprises washing the treated plant biomass with an organic solvent, water, or combination thereof.

4. The method of claim 2, further comprising drying the treated plant biomass before contacting the aqueous sample.

5. The method of claim 1, wherein contacting the plant biomass with the alkali solution comprises contacting the plant biomass selected from water hyacinth, elephant grass, jute, water lily, duck weed, azolla, wood, coir, banana, ramie, pineapple, sisal, cellulose, hemicellulose, lignin, and a combination thereof with the alkali solution.

6. The method of claim 5, wherein contacting the plant biomass with the alkali solution comprises contacting the plant biomass having an average particle size of about 1 micron to about 5000 microns with the alkali solution.

7. The method of claim 1, wherein contacting the plant biomass with the alkali solution comprises contacting the plant biomass with the alkali solution having a pH of about 11 to about 14.

8. The method of claim 7, wherein contacting the plant biomass with the alkali solution comprises contacting the plant biomass with the alkali solution for about 18 minutes to about 36 hrs at a temperature range of about 20° C. to about 130° C.

9. The method of claim 1, wherein contacting the plant biomass with the alkali solution comprises contacting the plant biomass with the alkali solution selected from sodium hydroxide, potassium hydroxide, calcium hydroxide, and a combination thereof.

10. The method of claim 1, wherein trans-esterifying the alkaline plant biomass comprises contacting the alkaline plant biomass with a vegetable oil, a fatty acid emulsion, phenolic resin, or any combination thereof.

11. The method of claim 10, wherein the trans-esterification of the alkaline plant biomass is performed at a temperature of about 90° C. to about 120° C. for at least one hour.

12. The method of claim 1, further comprising regenerating the biomass material by contacting the biomass material with an acid solution.

13. The method of claim 1, wherein the halide comprises a fluoride, a chloride, a bromide, an iodide, an organohalide, and any combination thereof.

14. A bio filter comprising a trans-esterified plant biomass having an average particle size of about 1 micron to about 5000 microns.

15. The bio filter of claim 14, wherein the plant biomass is selected from water hyacinth, elephant grass, jute, water lily, duck weed, azolla, wood, coir, banana, ramie, pineapple, sisal, cellulose, hemicellulose, lignin, and any combination thereof.

16. The bio filter of claim 14, wherein the trans-esterified plant biomass is in a containment structure having an influent inlet, an effluent outlet, and configured to pass a fluid from the influent inlet through the plant biomass, and then through the effluent outlet.
